(19) United States
(12) Patent Application Publication
(10) Pub. No.: US 2006/0282703 A1
(43) Pub. Date: Dec. 14, 2006

(54) Electronic apparatus and control method thereof

(75) Inventor: Gi-tai Nam, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd.

(21) Appl. No.: 11/450,371

(22) Filed: Jun. 12, 2006

(30) Foreign Application Priority Data
Jun. 14, 2005 (KR) 2005-50911

(51) Int. Cl. G06F 11/00

(52) U.S. Cl. 714/14

(57) ABSTRACT

An electronic apparatus to receive AC power from an external source includes a switch to control the AC power, and a controller to control the switch to cut off the AC power if a voltage level of the AC power exceeds a level of a predetermined upper limit voltage. Accordingly, the electronic apparatus automatically cuts off an over-voltage and reduces malfunctions due to the over-voltage.

### CROSS-REFERENCE TO RELATED APPLICATIONS

This application claims the benefit under 35 U.S.C. § 119 of Korean Patent Application No. 2005-50911, filed on Jun. 14, 2005, in the Korean Intellectual Property Office, the disclosure of which is incorporated herein in its entirety by reference.

### BACKGROUND OF THE INVENTION

1. Field of the Invention

The present general inventive concept relates to an electronic apparatus and a control method thereof, and more particularly, to an electronic apparatus which is driven by receiving AC power from an external power source and a control method thereof.

2. Description of the Related Art

Generally, an electronic apparatus including an image display apparatus is driven by a switching mode power supply which is highly efficient, small in size, and light in weight. The switching mode power supply comprises an AC power input part that inputs AC power, a rectifier to rectify the input AC power and to convert the AC power into DC power, a transformer to transform a voltage of the AC power rectified by the rectifier, a secondary rectifier to rectify the voltage transformed in the transformer, and a switching control IC (integrated circuit) in which a pulse width is modulated according to voltage levels of an output terminal of the rectifier.

If the voltage levels of the AC power initially applied to the electronic apparatus are not stable (i.e., if the voltage level of the AC power supplied to the electronic apparatus is beyond an allowable range), a plurality of diodes disposed in the rectifier are damaged. Also, an electrolyte of a capacitor, which is provided in a power terminal, leaks which may cause an explosion or fire and damage a power supply provided in the electronic apparatus, thereby causing malfunction of the electronic apparatus.

Conventionally, the AC power input part was connected with a fuse, or a large capacity capacitor which withstands over-voltage was used to settle the foregoing problem. However, the fuse cuts power when the over-voltage flows instead of cutting off power according to a voltage of the AC power input part. Even if the voltage level of the AC power rises to 50V through 150V, the over-voltage is not cut off effectively. By enlarging a capacity of the capacitor, a load may be prevented from damage due to the over-voltage. However, as the capacity of the capacitor becomes larger, production costs rise.

### SUMMARY OF THE INVENTION

Accordingly, the present general inventive concept provides an electronic apparatus, which automatically cuts off over-voltage and reduces malfunctions due to the over-voltage, and a control method thereof.

Additional aspects of the present general inventive concept will be set forth in part in the description which follows and, in part, will be obvious from the description, or may be learned by practice of the present general inventive concept.

The foregoing and/or other aspects of the present general inventive concept may be achieved by providing an electronic apparatus to receive AC power from an external power source, comprising a switch to control the AC power, and a controller to control the switch to cut off the AC power if a voltage level of the AC power exceeds a level of a predetermined upper limit voltage.

The controller may comprise a rectifier to rectify the AC power in half-waves and smooth the rectified AC power to output DC power, and a comparator to control the switch to cut off the AC power if a voltage level of the DC power output from the rectifier exceeds the level of the predetermined upper limit voltage.

The electronic apparatus may further comprise a zener diode to supply the predetermined upper limit voltage to the comparator.

The controller may further comprise a transistor which is turned on according to a current output from the comparator when the voltage level of the DC power output from the rectifier exceeds the level of the predetermined upper limit voltage, and when the transistor is turned on, the switch turns off.

The foregoing and/or other aspects of the present general inventive concept may also be achieved by providing a method of controlling an electronic apparatus which receives AC power from an external source, the method comprising rectifying the AC power in half-waves and smoothing the rectified AC power to generate DC power, generating a predetermined upper limit voltage using a zener diode, comparing a voltage level of the DC power with a level of the predetermined upper limit voltage, and cutting off the AC power if the voltage level of the DC power exceeds the level of the predetermined upper limit voltage.

The foregoing and/or other aspects of the present general inventive concept may also be achieved by providing a computer readable recording medium having executable codes to perform a method of controlling an electronic apparatus which receives AC power from an external source, the method comprising rectifying the AC power in half-waves and smoothing the rectified AC power to generate DC power, generating a predetermined upper limit voltage using a zener diode, comparing a voltage level of the DC power with a level of the predetermined upper limit voltage, and cutting off the AC power if the voltage level of the DC power exceeds the level of the predetermined upper limit voltage.

The foregoing and/or other aspects of the present general inventive concept may also be achieved by providing an electronic apparatus, comprising a load, a power supply to supply a power to the load, a switch disposed between the load and the power supply, and a control unit comprising a rectifier connected between the switch and the power supply to generate a rectified voltage, a comparator having a positive terminal to receive a voltage according to the rectified voltage, a negative terminal to receive another voltage as a reference voltage according to the rectified voltage, and an output terminal to output an output voltage according to the voltage and the other voltage, and a transistor to turn on or off the switch according to the output voltage.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a control block diagram illustrating an electronic apparatus according to an embodiment of the present general inventive concept;

FIG. 2 is a schematic circuit diagram illustrating a controller of the electronic apparatus of FIG. 1; and

FIG. 3 is a control flowchart illustrating a control method of the electronic apparatus of FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

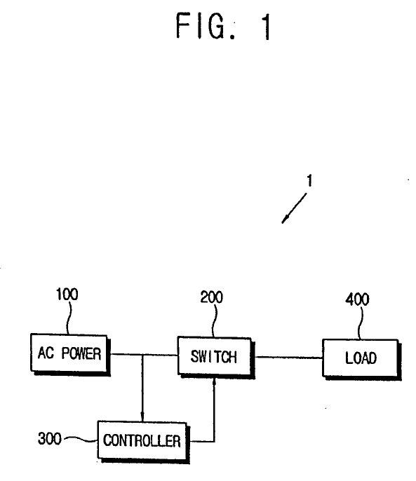

FIG. 1 is a control block diagram illustrating an electronic apparatus 1 according to an embodiment of the present general inventive concept. Referring to FIG. 1, the electronic apparatus 1 receives AC power from an external power source, for example, and AC power unit 100, to drive a load 400 which is provided in the electronic apparatus 1. The electronic apparatus 1 comprises a switch 200 to regulate the AC power, and a controller 300 to control the switch 200.

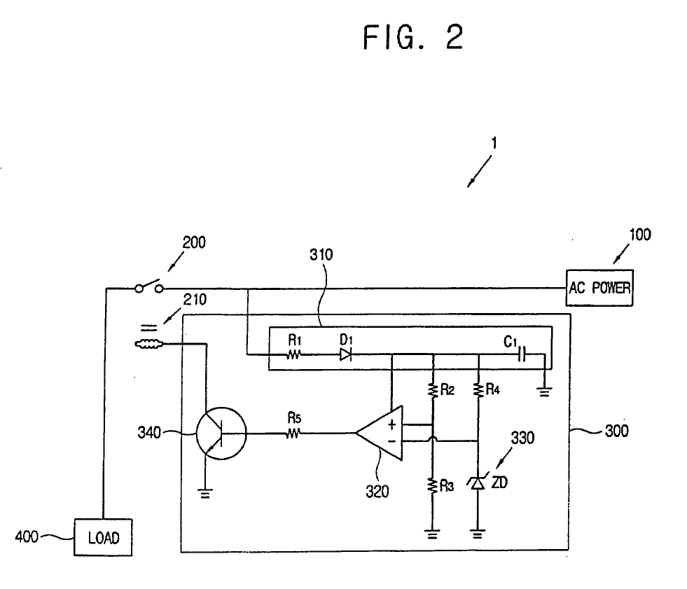

FIG. 2 is a schematic circuit diagram illustrating the controller 300 of the electronic apparatus 1 of FIG. 1. Referring to FIGS. 1 and 2, the electronic apparatus 1 comprises the switch 200 to regulate the AC power, and the controller 300 comprising a rectifier 310, a comparator 320, a zener diode 330, and a transistor 340.

The AC power may be commercial power, and a frequency and effective value (root mean square value) of the input AC power may vary according to a country or region. Where there is stable power supply, voltage fluctuation of the AC power may not be great and damage due to an over-voltage of the AC power may not be severe. However, where the power supply is not stable and the voltage fluctuation of the AC power is great, the electronic apparatus 1 can be damaged due to a sudden over-voltage of the AC power. For example, in Korea, a voltage fluctuation rate of the AC power is ±2-5%, and the effective values of 220V, 110V, and 380V are supplied at a frequency of 60 Hz.

The load 400 is driven by the AC power, which is input through an input terminal. The switch 200 is provided between the input terminal of the AC power unit 100 and the load 400 to regulate the AC power, and the controller 300 controls the switch 200 by detecting a voltage level of the AC power.

The switch 200 may comprise a relay switch which is controlled electrically. An electromagnet 210 can be used to electrically control the switch 200. When a current flows in a coil of the electromagnet 210, the coil of the electromagnet 210 generates an electromagnetic force and the switch 200 is turned off by the electromagnetic force. When the current is cut off from the coil of the electromagnet 210, the electromagnetic force is cut off and the switch 200 is turned on. If the switch 200 receives the AC power at the voltage level included in a predetermined normal range, the controller 300 cuts off the current to flow in the coil of the electromagnet 210, and the switch 200 is turned on and connects the AC power unit 100 and the load 400.

If the AC power exceeds a predetermined upper limit voltage level, the controller 300 controls the current to flow in the coil of the electromagnet 210, and the switch 200 is turned off by the electromagnetic force to cut off the AC power supplied to the load 400 of the electronic apparatus 1. The current may not be easily cut off from the coil of the electromagnet 210 due to a characteristic of the coil which allows the current to flow continuously therein. Accordingly, the electronic apparatus 1 may further comprise a flyback diode to cut off the current without difficulty.

The switch 200 may be provided as a mechanical switch which is easily controlled and effective, but the present general inventive concept is not limited thereto. For example, the switch 200 may be turned on and off using software which designates a predetermined bit of a predetermined register and applies a signal of 0 or 1 to turn the switch 200 of or on, respectively. The electromagnetic force generated by the electromagnet 210 may be a repulsion force to physically move the switch to an open position when the current flows in the coil.

The rectifier 310 comprises a first resistor R1, a diode D1, and a capacitor C1. The rectifier 310 rectifies the AC power in half-waves and smoothes the rectified AC power. The AC power is rectified in the half-waves by the first resistor R1 and the diode D1. The rectified AC power is then smoothed by the capacitor C1 to be output as stable DC power.

The output DC power is input to a first terminal of the comparator 320 as bias power, is divided by a second resistor R2 and a third resistor R3 into a voltage to be input to a second terminal (a non-inverting terminal) of the comparator 320, and is provided as a reverse voltage to the zener diode (ZD) 330 through a fourth resistor R4.

The zener diode 330 comprises an inherent voltage level at which a zener breakdown is generated. In the zener diode 330, a current does not flow until reaching the inherent voltage level, but flows after reaching the inherent voltage level. When a zener voltage applied to the zener diode 330 is at the inherent voltage level, the zener voltage does not increase and the current does increase. Accordingly, a reference voltage, such as an upper limit voltage, may be generated using this characteristic of the zener diode 330. A level of the upper limit voltage is set to prevent fire or explosion of electric elements in the load 400. The level of the upper limit voltage may be controlled in various manners according to a type of the AC power and a capacity of the capacitor C1 disposed in the electronic device 1. The level of the upper limit voltage may be changed by using zener diodes 330 having different zener voltages. The upper limit voltage generated by the fourth resistor R4 and the zener diode 330 is input to a third terminal (i.e., an inverting terminal) of the comparator 320.

As illustrated in FIG. 2, the upper limit voltage is generated using the DC power output from the rectifier 310, however the upper limit voltage may alternatively be generated using voltage generated by an additional voltage generator.

The DC power divided into the voltage through the second resistor R2 and the third resistor R3 is input to the second terminal of the comparator 320 to provide a value of the voltage level of the AC power currently provided, to the comparator 320.

The comparator 320 compares the levels of the DC power input to the second terminal and the upper limit voltage input to the third terminal. If the level of the DC power is greater than that of the upper limit voltage, the comparator 320 outputs a current through the fourth terminal as an output terminal.

The current output from the comparator 320 passes through a fifth resistor R5 and applies a bias voltage to the transistor 340. If the bias voltage is applied to the transistor 340, the current flows from a collector of the transistor 320 to an emitter of the transistor, and the transistor 340 is turned on. When the transistor 340 is turned on, the current flows therethrough, and the switch 200 is electrically turned off by an electromagnetic field formed by the coil of the electromagnet 210. Accordingly, the AC power supplied to the load 400 is automatically cut off.

When the AC power is cut off from the load 400, the comparator 320 outputs the current until the voltage level of the AC power is no longer greater than the level of the upper limit voltage. Accordingly, when the voltage level of the AC power is no longer greater than the level of the upper limit voltage, the bias voltage is not applied to the transistor 340, the current flowing in the coil of the electromagnet 210 is cut off, and the switch 200 is turned on again.

The electronic apparatus 1 may further comprise an RC filter (not shown) and a choke coil (not shown) to remove noise from the AC power 100 before the rectifier 310 receives the AC power to rectify and smooth the AC power.

Also, the electronic apparatus 1 may further comprise a fuse (not shown) to prevent a current level of the AC power from being beyond the predetermined normal range. As described above, the controller 300 is provided to cut off the AC power when the over-voltage is supplied. Accordingly, the controller 300 prevents the over-voltage and the fuse prevents an over-current.

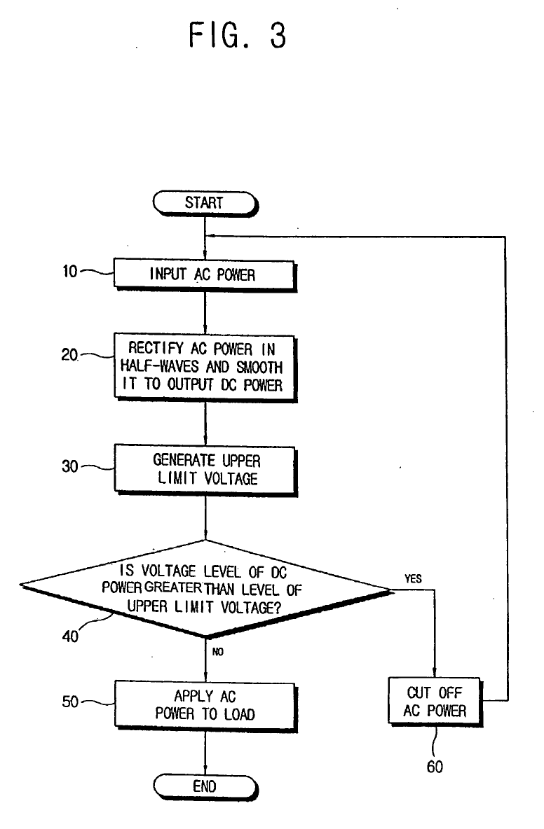

FIG. 3 is a control flowchart illustrating a method of controlling the electronic apparatus 1 according to an embodiment of the present general inventive concept. Referring to FIGS. 1-3, when the AC power is input from the AC power unit 100 at operation 10, the rectifier 310 rectifies the AC power in half-waves and smoothes the rectified AC power to output the DC power at operation 20. The DC power is used to generate the predetermined upper limit voltage through the fourth resistor R4 and the zener diode 330 at operation 30, and the predetermined upper limit voltage is input to the third terminal of the comparator 320. The comparator 320 compares the voltage level of the DC power input to the second terminal of the comparator 320 after being divided by the second and third resistors R2 and R3, and the level of the upper limit voltage input to the third terminal at operation 40. If the voltage level of the DC power is less than or equal to that of the upper limit voltage, the AC power is applied to the load 400 at operation 50. If the voltage level of the DC power is greater than that of the upper limit voltage, the switch 200 is turned off by the current output from the comparator 320 and the AC power is cut off from the load 400 at operation 60. Accordingly, the AC power which exceeds the predetermined upper limit voltage is not supplied to the load 400, thereby preventing damage in the electronic apparatus 1. When the switch 200 is turned off and the AC power supplied to the electronic apparatus 1 is reduced, the switch 200 is turned on again to supply the AC power to the load 400, thereby controlling the supply of the AC power through repetition of the foregoing process.

It is possible for the present general inventive concept to be realized on a computer-readable recording medium as a computer-readable code. Computer-readable recording mediums include many types of recording devices that store computer system-readable data. ROMs, RAMs, CD-ROMs, magnetic tapes, floppy discs, optical data storage, etc. are used as computer-readable recording mediums. Computer-readable recording mediums can also be realized in the form of carrier waves (e.g., transmission via Internet).

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electronic apparatus to receive AC power from an external power source, comprising:
a switch to control the AC power; and
a controller to control the switch to cut off the AC power if a voltage level of the AC power exceeds a level of a predetermined upper limit voltage.

2. The electronic apparatus according to claim 1, wherein the controller comprises:
a rectifier to rectify the AC power in half-waves and smooth the rectified AC power to output DC power; and
a comparator to control the switch to cut off the AC power if a voltage level of the DC power output from the rectifier exceeds the level of the predetermined upper limit voltage.

3. The electronic apparatus according to claim 2, further comprising:
a zener diode to supply the predetermined upper limit voltage to the comparator.

4. The electronic apparatus according to claim 3, wherein the zener diode is connected to the rectifier to receive the DC power from the rectifier and to output the predetermined upper limit voltage in response to the received DC power.

5. The electronic apparatus according to claim 2, wherein the controller further comprises:
a transistor which is turned on according to a current output from the comparator when the voltage level of the DC power output from the rectifier exceeds the level of the predetermined upper limit voltage, and when the transistor is turned on, the switch turns off.

6. The electronic apparatus according to claim 5, wherein the controller further comprises:
an electromagnet to receive a current output from the transistor when the transistor is turned on and to generate an electromagnetic force according to the received current to turn the switch off.

7. The electronic apparatus according to claim 6, wherein the electromagnetic force comprises a repulsion force to physically move the switch to an open position.

8. The electronic apparatus according to claim 7, wherein when the electromagnetic force is cut off the switch moves to a closed position.

9. The electronic apparatus according to claim 1, wherein in a state in which the switch has cut off the AC power, the controller controls the switch to receive the AC power when the voltage level of the AC power does not exceed the level of the predetermined upper limit voltage.

10. The electronic apparatus according to claim 1, further comprising:
a comparator to compare the voltage level of the AC power and the level of the predetermined upper limit voltage, to control the switch to cut off the AC power when the voltage level of the AC power is greater than the level of the predetermined upper limit voltage, and to control the switch to supply the AC power to a load when the voltage level of the AC power is not greater than the level of the predetermined upper limit voltage level.

11. A method of controlling an electronic apparatus which receives AC power from an external source, the method comprising:
rectifying the AC power in half-waves and smoothing the rectified AC power to generate DC power;
generating a predetermined upper limit voltage using a zener diode;
comparing a voltage level of the DC power with a level of the predetermined upper limit voltage; and
cutting off the AC power if the voltage level of the DC power exceeds the level of the predetermined upper limit voltage.

12. The method according to claim 11, further comprising:
supplying the AC power to a load of the electronic apparatus whenever the voltage level of the DC power does not exceed the level of the predetermined upper limit voltage.

13. A computer readable medium having executable codes to perform a method of controlling an electronic apparatus which receives AC power from an external source, the method comprising:
rectifying the AC power in half-waves and smoothing the rectified AC power to generate DC power;
generating a predetermined upper limit voltage using a zener diode;
comparing a voltage level of the DC power with a level of the upper limit voltage; and
cutting off the AC power if the voltage level of the DC power exceeds the level of the upper limit voltage.

14. An electronic apparatus, comprising:
a load;
a power supply to supply a power to the load;
a switch disposed between the load and the power supply; and
a control unit comprising a rectifier connected between the switch and the power supply to generate a rectified voltage, a comparator having a positive terminal to receive a voltage according to the rectified voltage, a negative terminal to receive another voltage as a reference voltage according to the rectified voltage, and an output terminal to output an output voltage according to the voltage and the other voltage, and a transistor to turn on or off the switch according to the output voltage.

15. The electronic apparatus according to claim 14, wherein the control unit further comprises:
a zener diode connected between a ground potential and a junction between the negative terminal and the rectifier to generate the other voltage.

16. The electronic apparatus according to claim 15, wherein when the power is greater than a predetermined voltage, the voltage is greater than the other voltage to turn on the transistor to control the switch to terminate a supply of the power from the power supply to the load.

17. The electronic apparatus according to claim 15, wherein when the power is less than a predetermined voltage, the voltage is less than the other voltage to turn off the transistor to control the switch to continue a supply of the power from the power supply to the load.

18. The electronic apparatus according to claim 14, wherein the rectifier comprises a resistor and a diode connected in series between the power supply and the comparator, and a capacitor connected between the diode and a ground potential, and the positive and negative terminals of the comparator are connected to a junction between the diode and the capacitor.

19. The electronic apparatus according to claim 18, wherein the positive terminal is connected between resistors which are connected to the rectifier and the ground potential, respectively, and the negative terminal is connected between a resistor and a zener diode which are connected between the rectifier and the ground potential, respectively.
